(19) United States
(12) Patent Application Publication
(10) Pub. No.: US 2007/0091872 A1
(43) Pub. Date: Apr. 26, 2007

(54) Peer-to-peer connection establishment

(75) Inventor: Martin Bergenwall, Julkujarvi (FI)

Correspondence Address: SQUIRE, SANDERS & DEMPSEY L.L.P., 14TH FLOOR, 8000 TOWERS CRESCENT, TYSONS CORNER, VA, 22182, US

(73) Assignee: NOKIA CORPORATION

(21) Appl. No.: 11/289,686

(22) Filed: Nov. 30, 2005

(30) Foreign Application Priority Data
Oct. 21, 2005 (FI) 20051061

(51) Int. Cl. H04L 12/66

(52) U.S. Cl. 370/352

(57) ABSTRACT

Method, devices and computer programs for initiating and establishing a peer-to-peer connection between a mobile terminal and a data terminal. The mobile terminal constructs a signaling message comprising an internet protocol address of each communication interface when the number of communication interfaces is at least two. The addresses may be ordered in a preference order. A receiving data terminal then tries to initiate communication with a first internet protocol address, and if the initiation fails, selects the next internet protocol address for communication initiation.

### BACKGROUND OF THE INVENTION

1. Field of the Invention

The present invention relates to data terminals. In particular, the present invention relates to a novel and improved method, a mobile terminal, a data terminal, computer programs and a data structure for initiating and establishing a peer-to-peer connection between two terminals.

2. Description of the Related Art

A peer-to-peer (or P2P) computer network is a network that relies on the computing power and bandwidth of the participants in the network rather than concentrating it in a relatively few servers. Peer-to-peer networks are typically used for connecting nodes via largely ad hoc connections. Such networks are useful for many purposes. Sharing content files containing audio, video, data or anything in a digital format is very common, and realtime data, such as telephony traffic, is also passed using peer-to-peer technology. Peer-to-peer is a communications model in which each party has the same capabilities and either party can initiate a communication session. On the Internet, peer-to-peer is a type of transient Internet network that allows a group of computer users with the same networking program to connect with each other and directly access files e.g. from one another's hard drives.

Existing peer-to-peer applications and protocols are designed for personal computers comprising only one communication interface. This means that handshakings and peer-to-peer connection maintenance as well as downloading is communicated over the same Internet Protocol (IP) interface, typically using different TCP/UDP ports (TCP, Transmission Control Protocol; UDP, User Datagram Protocol). This approach is good and optimized for a personal computer environment.

With mobile terminals there is a possibility that the connection and downloading of files could be done over an alternative interface that in fact could be cheaper, faster and less battery consuming.

As an example, two mobiles equipped with mobile packet data capabilities and a wireless local area network (WLAN) may communicate over mobile packet data and agree to share a file. The two mobiles happen to be temporarily located close to each other connected to the same local (ad-hoc) WLAN network. An existing peer-to-peer application would resume the peer-to-peer communication and downloading over the mobile packet data interface that was used to find the other peer.

Furthermore, a problem is caused by local private networks that use overlapping IP addressing, such as addresses in 10.x.x.x network, 192.168.254.x network or 169.254.x.x link local network. Therefore, for example, if two mobile terminals are both connected to a WLAN, they are not able to definitely know whether they are connected to the same local network (WLAN).

### SUMMARY OF THE INVENTION

According to a first aspect of the invention, there is provided a method of initiating communication from a peer-to-peer application of a mobile terminal. The method comprises determining the number of communication interfaces in the mobile terminal, adding internet protocol addresses of each communication interface to a signaling message when the number of communication interfaces is at least two, adding at least one host descriptor of the mobile terminal to the signaling message, and sending the signaling message to a receiving entity via a public communication interface.

In one embodiment of the invention, the method further comprises determining, for each communication interface, whether a communication interface is a local communication interface, and when the interface is a local communication interface, adding a local network indicator for the communication interface in the signaling message, and adding at least one host descriptor of the mobile terminal in the signaling message.

In one embodiment of the invention, the method further comprises ordering the communication interfaces in a preference order in the signaling message.

In one embodiment of the invention, the method further comprises adding a separate host descriptor for each communication interface in the signaling message.

In one embodiment of the invention, the host descriptor comprises at least part of a Media Access Control address of the mobile terminal.

In one embodiment of the invention, the receiving entity is a data terminal. In another embodiment of the invention, the receiving entity is a server computer.

According to a second aspect of the invention, there is provided a method of establishing a connection from a data terminal to a mobile terminal. The method comprises receiving, with the data terminal, a signaling message comprising internet protocol addresses of at least two communication interfaces of the mobile terminal, each communication interface being identified by a corresponding internet protocol address, selecting a first internet protocol address from the signaling message, the internet protocol address corresponding to a communication interface, validating a host descriptor comprised in the signaling message, the host descriptor corresponding to the communication interface, initiating communication with the internet protocol address corresponding to a validated host descriptor, and selecting a next internet protocol address for validation and communication initiation if the validating step or initiating step fails.

In one embodiment of the invention, the method further comprises determining whether the first internet protocol address in the signaling message belongs to a local network; and if the internet protocol address is a local network address, determining whether the data terminal belongs to the local network, and selecting the next internet protocol address from the signaling message if the data terminal does not belong to the local network.

In one embodiment of the invention, the method further comprises selecting the internet protocol addresses of the communication interfaces from the signaling message according to a preference order.

In one embodiment of the invention, the method further comprises determining, based on a local network indicator, whether the first internet protocol address in the signaling message belongs to a local network.

In one embodiment of the invention, the host descriptor comprises at least part of a Media Access Control address.

In one embodiment of the invention, the receiving step comprises receiving the signaling message from the mobile terminal.

In one embodiment of the invention, the receiving step comprises receiving the signaling message from a server computer.

According to a third aspect of the invention, there is provided a mobile terminal configured to initiate communication with a peer-to-peer application. The mobile terminal is configured to determine the number of communication interfaces in the mobile terminal, to add internet protocol addresses of each communication interface to a signaling message when the number of communication interfaces is at least two, to add at least one host descriptor of the mobile terminal to the signaling message, and to send the signaling message to a receiving entity via a public communication interface.

According to a fourth aspect of the invention, there is provided a data terminal configured to establish a peer-to-peer connection with a mobile terminal. The data terminal is configured to receive a signaling message comprising internet protocol addresses of at least two communication interfaces of the mobile terminal, each communication interface being identified by a corresponding internet protocol address, to select a first internet protocol address from the signaling message, the first internet protocol address corresponding to a communication interface, to validate a host descriptor comprised in the signaling message, the host descriptor corresponding to the communication interface, to initiate communication with the first internet protocol address corresponding to a validated host descriptor, and select the next internet protocol address for validation and communication initiation if the validating step or initiating step fails.

According to a fifth aspect of the invention, there is provided a computer program for initiating communication, embodied on a computer-readable medium, the computer program comprising code adapted to perform the following steps when executed on a data-processing device: determine the number of communication interfaces in a mobile terminal, add internet protocol addresses of each communication interface to a signaling message when the number of communication interfaces is at least two, add at least one host descriptor of the mobile terminal to the signaling message, and send the signaling message to a receiving entity via a public communication interface.

According to a sixth aspect of the invention, there is provided a computer program for establishing a peer-to-peer connection, embodied on a computer-readable medium, the computer program comprising code adapted to perform the following steps when executed on a data-processing device: receiving, with a data terminal, a signaling message comprising internet protocol addresses of at least two communication interfaces of the mobile terminal, each communication interface being identified by a corresponding internet protocol address, selecting a first internet protocol address from the signaling message, the internet protocol address corresponding to a communication interface, validating a host descriptor comprised in the signaling message, the host descriptor corresponding to the communication interface, initiating communication with the first internet protocol address corresponding to a validated host descriptor, and selecting the next internet protocol address for validation and communication initiation if the validating step or initiating step fails.

According to a seventh aspect of the invention, there is provided a data structure for communication initiation with a peer-to-peer application. The data structure comprises at least two internet protocol addresses, wherein each internet protocol address identifies a communication interface of a mobile terminal, and at least one host descriptor of the mobile terminal.

In one embodiment of the invention, the data structure further comprises a local network indicator for each local communication interface.

In one embodiment of the invention, the data structure further comprises the communication interfaces are ordered in a preference order.

In one embodiment of the invention, the data structure further comprises the host descriptor comprises at least part of a Media Access Control address of the mobile terminal.

The present invention has several advantages over the prior-art solutions. The invention provides a generic and optimum way for all peers to discover alternative communication paths. Furthermore, the invention provides a cost effective way to share information in a situation in which a mobile terminal is connected to a local network that is in turn connected to the Internet. Due to the invention, the number of failed communication attempts is minimized.

Furthermore, the invention enables to automatically perform downloads over local interfaces if both peers are connected to the same local network.

### BRIEF DESCRIPTION OF THE DRAWINGS

The accompanying drawings, which are included to provide a further understanding of the invention and constitute a part of this specification, illustrate embodiments of the invention and together with the description help to explain the principles of the invention. In the drawings:

FIG. 1 discloses a flow diagram illustrating one embodiment of a method according to the invention,

FIG. 2 discloses a flow diagram illustrating one embodiment of a method according to the invention,

FIG. 3 discloses a flow diagram illustrating another embodiment of a method according to the invention,

FIG. 4 discloses a flow diagram illustrating another embodiment of a method according to the invention,

FIG. 5a discloses an embodiment according to the invention, in which a content sharer has two public interfaces,

FIG. 5b discloses another embodiment according to the invention, in which a content sharer has one public interface and one local interface and a content downloader has one public interface,

FIG. 5c discloses another embodiment according to the invention, in which a content sharer has one public interface and one local interface and a content downloader has one public interface and one local interface, wherein the local interfaces are not connected with each other,

FIG. 5d discloses another embodiment according to the invention, in which a content sharer has one public interface and one local interface and a content downloader has one public interface and one local interface, wherein the local interfaces are connected with each other, and

FIG. 6 discloses one embodiment of a data structure according to the invention.

### DETAILED DESCRIPTION OF THE PREFERRED EMBODIMENTS

Reference will now be made in detail to the embodiments of the present invention, examples of which are illustrated in the accompanying drawings.

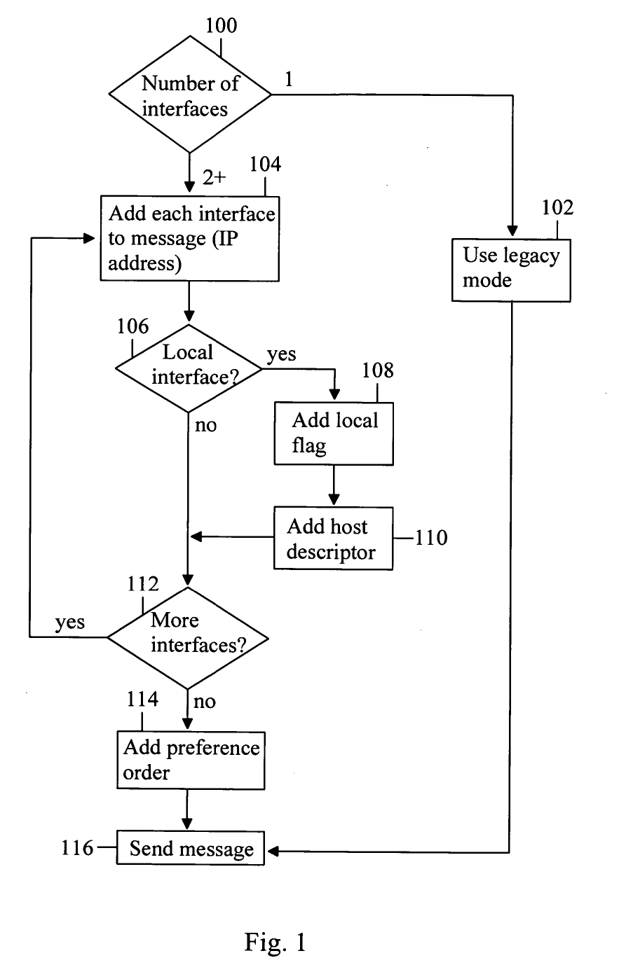

FIG. 1 discloses a flow diagram of one embodiment of a method according to the invention. FIG. 1 illustrates a situation when a mobile terminal having multiple communication interfaces signals information relating to a peer-to-peer connection establishment to another mobile terminal.

At step 100, a peer-to-peer application in the first mobile terminal determines the number of communication interfaces. A communication interface may be a public interface or a local interface. A public address, e.g. a public Internet protocol address (IP) is assigned to the public communication interface. Therefore, the mobile terminal is able to send and receive packets via the public interface e.g. from the Internet. A local interface does not have a public IP address. For example, a local address may be applicable only e.g. within a local private network. A local interface may have access to the Internet through a network address translation (NAT) device or may be totally isolated from other networks.

If the number of communication interfaces in the mobile terminal is only one, the peer-to-peer application functions just as in a normal peer-to-peer communication case (step 102).

If the number of communication interfaces exceeds one, the IP address of each communication interface is added to a signaling message (step 104). If a communication interface is a local interface (step 106), a local flag may be added in the signaling message. The local flag may be a single bit (e.g. 1 (flag on), 0 (flag off)) or any other appropriate indicator. The purpose of the local flag is to signal to a receiving mobile terminal that this address belongs to a local address space. The mere using of a local flag, however, is not sufficient for identifying the local communication interface. The receiving mobile terminal has to have additional information in order to determine whether the local address may be used in communication.

The peer-to-peer application adds (step 110) also another piece of identification information into the signaling message. A host descriptor identifies the host (or interface access device). The host descriptor is e.g. a Media Access Control (MAC) address of the local communication interface, part of the MAC address or a hash of the MAC address. The hash may be computed with any appropriate hashing function, e.g. SHA1 (Secure Hashing Algorithm) or MD5 (Message Digest). The hash or MAC address does not have to be fully in the signaling message. For example, in one embodiment 32 last bits of it may be used. The host descriptor may also indicate whether a hash function is used or not and which hash function is used. In another embodiment, an indicator indicating whether a hash function is used and which hash function is used may be a separate indicator from the host descriptor.

The host descriptor is not limited to the usage of MAC addresses; instead, any other appropriate host descriptor may be used as long as the host descriptor reliably identifies the host.

At step 112, it is determined whether there are further communication interfaces still to be processed. If all interfaces have been processed, interfaces in the signaling message may be ordered in a preference order (step 114). It is evident to a man skilled in the art the ordering may also be an optional step. Now the signaling message is ready to be sent (116). The message may be sent directly to a receiving mobile terminal. In another embodiment, the message is sent to a server computer located somewhere in the Internet. At some point, the server then sends the signaling message to the receiving mobile terminal.

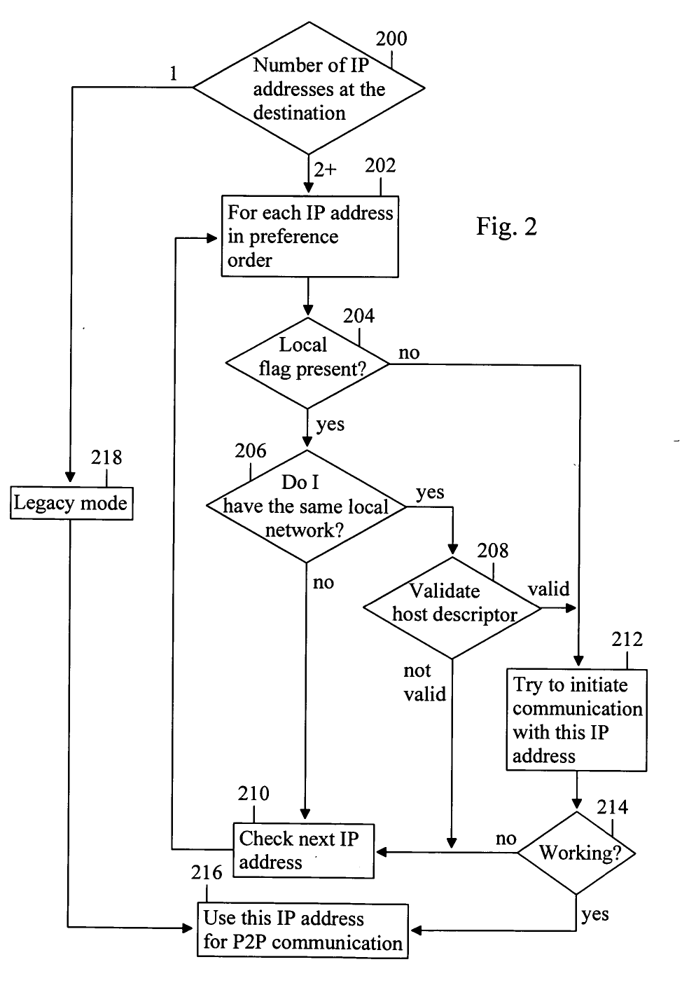

FIG. 2 discloses a flow diagram of one embodiment of a method according to the invention. In practice, the diagram illustrates an embodiment in which a signaling message constructed according to the embodiment of FIG. 1 is received in a receiving mobile terminal.

At step 200, a peer-to-peer application in the mobile terminal determines the number of communication interfaces (separate Internet protocol addresses). If the number of communication interfaces is only one, the peer-to-peer application in the mobile terminal functions just as in a normal peer-to-peer communication case (step 218).

Each of the addresses is gone through (step 202) according to a preference order set by the peer-to-peer application in a mobile terminal that sent the signaling message. First, the peer-to-peer application determines whether there exists a local flag in connection with the processed IP address (step 204). If a local flag (local network indicator) is not present, the peer-to-peer application tries to initiate communication with the IP address (step 212). If the initiation was successful, the IP address is used for peer-to-peer communication (step 216). If the initiation was not successful, the processing advances to the next IP address in the signaling message (step 210).

If the processed IP address is determined to be in the same address space than the own local network of the receiving mobile terminal (step 206), the processing advances to step 208. At step 208 the host descriptor corresponding to the processed IP address is validated. The term validation refers to at least one step to determine whether the host descriptor refers to a host or e.g. to a MAC address that is actually present in the local network. The host descriptor identifies the host (or interface access device). The host descriptor is e.g. a Media Access Control (MAC) address of the local communication interface or a hash of the MAC address. The hash may have been computed with any appropriate hashing function, e.g. SHA1 (Secure Hashing Algorithm) or MD5 (Message Digest). The hash or MAC address may not be fully in the signaling message. For example, in one embodiment 32 last bits of it may be used. The host descriptor may also indicate whether a hash function is used or not and which hash function is used. In another embodiment, an indicator indicating whether a hash function is used and which hash function is used may be a separate indicator from the host descriptor.

The peer-to-peer application determines the validity of the host descriptor e.g. with the Address Resolution Protocol (ARP). For example, based on the local IP address it is possible to resolve the MAC address attached to the local IP address. If the host descriptor is considered valid, the peer-to-peer application tries to initiate communication with the IP address (step 212). If the host descriptor is not considered valid, the processing advances to the next IP address in the signaling message (step 210).

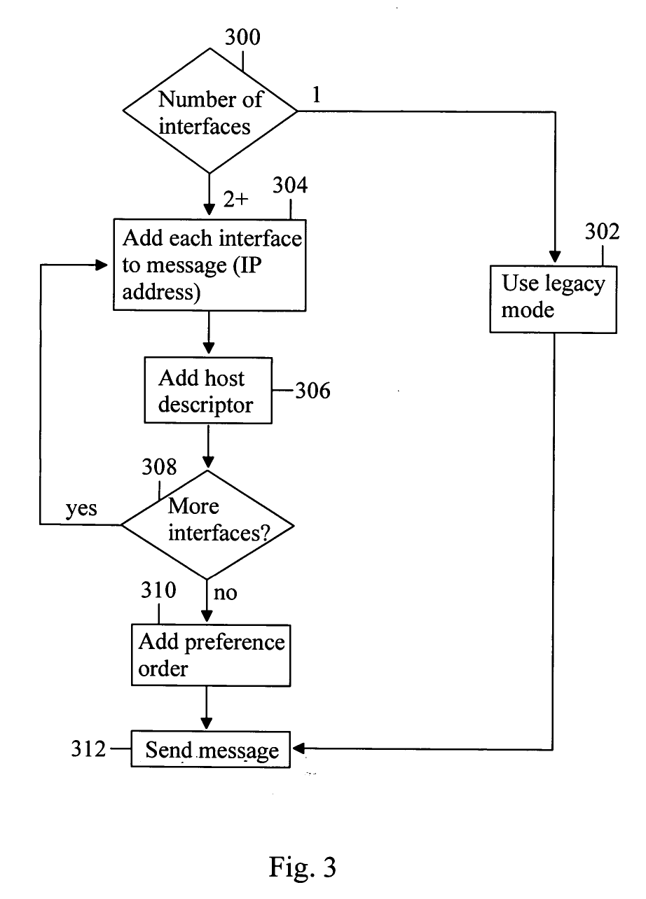

FIG. 3 discloses a flow diagram of another embodiment of a method according to the invention. FIG. 3 illustrates a situation when a mobile terminal having multiple communication interfaces signals information relating to a peer-to-peer connection establishment to another mobile terminal. The established connection may be a download connection, it may relate e.g. to Instant Messaging to Voice over IP traffic or to any other type of messaging.

At step 300, a peer-to-peer application in the first mobile terminal determines the number of communication interfaces. A communication interface may be a public interface or a local interface. A public address, e.g. a public Internet protocol address (IP) is assigned to a public communication interface. Therefore, the mobile terminal is able to send and receive packets via the public communication interface e.g. from the Internet. A local communication interface does not have a public IP address. For example, a local address may be applicable only e.g. within a local private network.

If the number of communication interfaces in the mobile terminal is only one, the peer-to-peer application functions just as in a normal peer-to-peer communication case (step 302).

If the number of communication interfaces exceeds one, the IP address of each communication interface is added to a signaling message (step 304). The peer-to-peer application adds (step 110) a host descriptor in the signaling message. The host descriptor identifies the host (or interface access device). The host descriptor is e.g. a Media Access Control (MAC) address of the local communication interface or a hash of the MAC address. The hash may be computed with any appropriate hashing function, e.g. SHA1 (Secure Hashing Algorithm) or MD5 (Message Digest). The hash or MAC address does not have to be fully in the signaling message. For example, in one embodiment 32 last bits of it may be used. The host descriptor may also indicate whether a hash function is used or not and which hash function is used. In another embodiment, an indicator indicating whether a hash function is used and which hash function is used may be a separate indicator from the host descriptor.

The host descriptor is not limited to the usage of MAC addresses but any other appropriate host descriptor may be used.

At step 308, it is determined whether there are further communication interfaces still to be processed. If all interfaces have been processed, interfaces in the signaling message may be ordered in a preference order (step 310). It is evident to a man skilled in the art the ordering may also be an optional step. Now the signaling message is ready to be sent (step 312). The message may be sent directly to a receiving mobile terminal. In another embodiment, the message is sent to a server computer located somewhere in the Internet. At some point, the server then sends the signaling message to the receiving mobile terminal.

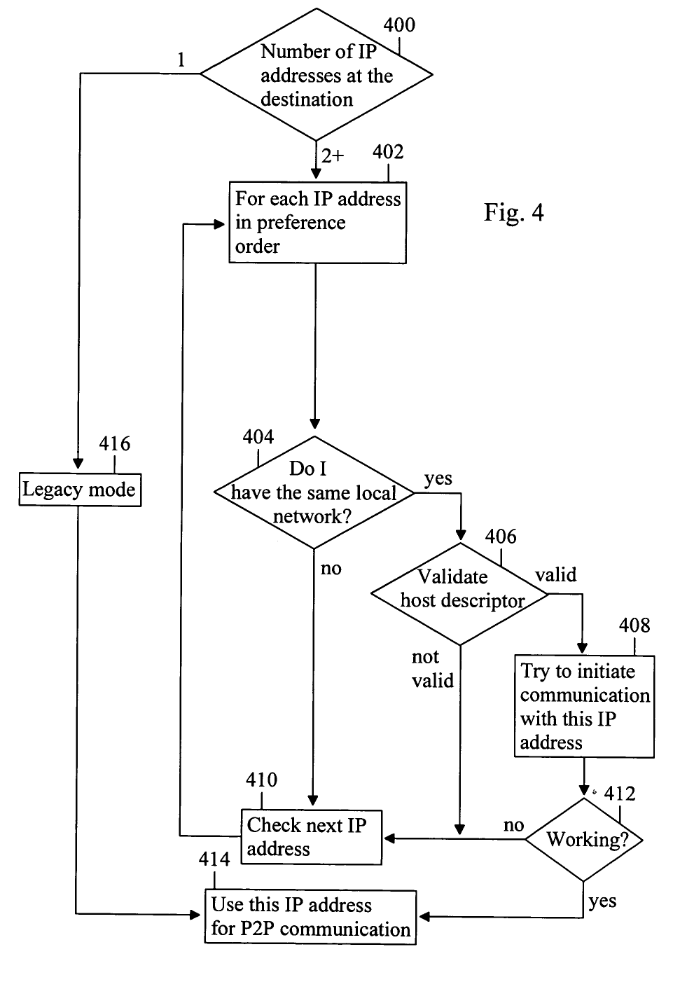

FIG. 4 discloses a flow diagram of one embodiment of a method according to the invention. In practice, the diagram illustrates an embodiment in which a signaling message constructed according to the embodiment of FIG. 3 is received in a receiving mobile terminal.

At step 400, a peer-to-peer application in the mobile terminal determines the number of communication interfaces (separate Internet protocol addresses). If the number of communication interfaces is only one, the peer-to-peer application in the mobile terminal functions just as in a normal peer-to-peer communication case (step 416).

Each of the addresses is gone through (step 402) according to a preference order set by the peer-to-peer application in a mobile terminal that sent the signaling message. If the processed IP address is determined to be in the same address space than the local network of the receiving mobile terminal (step 404), the processing advances to step 406. At step 406 the host descriptor corresponding to the processed IP address in validated. The term validation refers to at least one step to determine whether the host descriptor refers to a host or e.g. to a MAC address that is actually present in the local network. The host descriptor identifies the host (or interface access device). The host descriptor is e.g. a Media Access Control (MAC) address of the local communication interface or a hash of the MAC address. The hash may have been computed with any appropriate hashing function, e.g. SHA1 (Secure Hashing Algorithm) or MD5 (Message Digest). The hash or MAC address may not be fully in the signaling message. For example, in one embodiment 32 last bits of it may be used. The host descriptor may also indicate whether a hash function is used or not and which hash function is used. In another embodiment, an indicator indicating whether a hash function is used and which hash function is used may be a separate indicator from the host descriptor.

The peer-to-peer application determines the validity of the host descriptor e.g. with the Address Resolution Protocol (ARP). For example, based on the local IP address it is possible to resolve the MAC address attached to the local IP address. If the host descriptor is considered valid, the peer-to-peer application tries to initiate communication with the IP address (step 408). If the host descriptor is not valid, the processing advances to the next IP address in the signaling message (step 410).

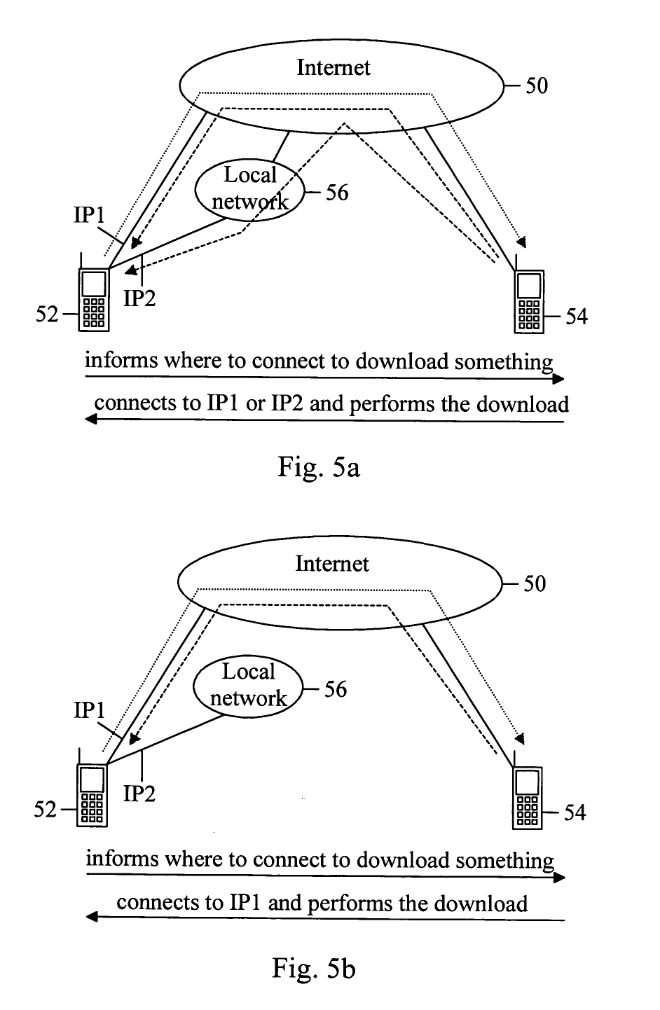

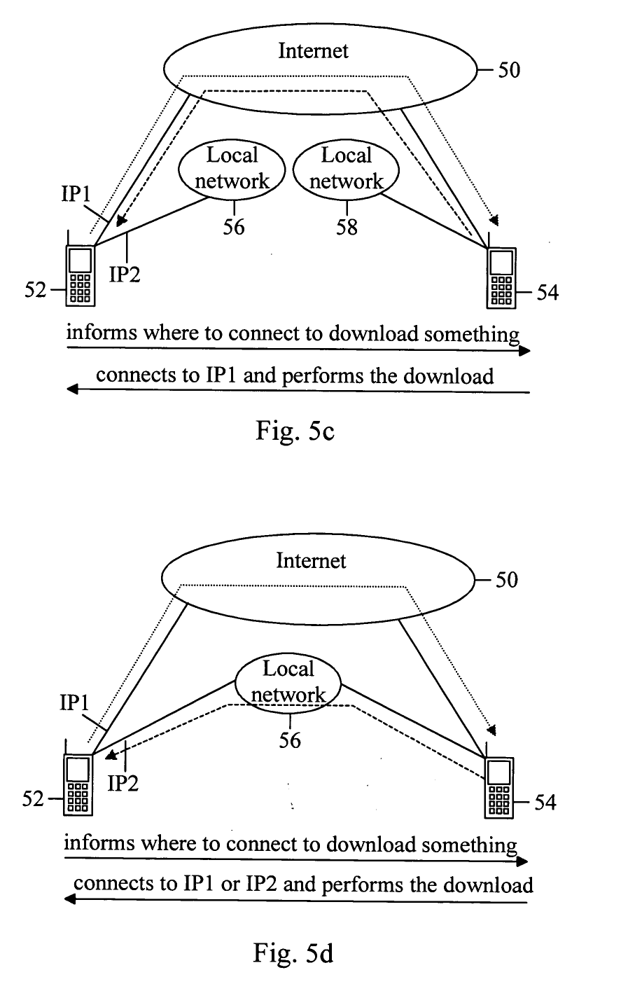

FIG. 5a illustrates one possible embodiment in which the invention may be used. The system disclosed in FIG. 5a comprises a mobile terminal 52 and a data terminal 54. The mobile terminal 52 is connected to the Internet 50 e.g. via the General Packet Radio System (GPRS) or 3^{rd} generation mobile packet data connection. The data terminal 54 may be a computer or a mobile terminal. The mobile terminal is e.g. a mobile phone or any other appropriate device. For simplicity, the data terminal 54 is also a mobile terminal in this example.

The first mobile terminal 52 is connected also to a local network 56 via another wireless connection, e.g. a Wireless Local Area Network (WLAN) connection. The local network 56 is also connected to the Internet 50. In this embodiment, the first mobile terminal 52 has two public interfaces, IP1 and IP2, to which are assigned a public IP address. Therefore, the first mobile terminal 52 may receive data from the second mobile terminal 54 via both interfaces IP1 and IP2.

As disclosed e.g. in the description of FIG. 1, the first mobile terminal 52 sends a signaling message to the second mobile terminal 54 and informs where (which interface) to connect to download something. The second mobile terminal 54 connects to the interface IP1 or IP2 and performs the download. The first mobile terminal 52 may have set a preference order for the interfaces in the signaling message. Therefore, the second mobile terminal 54 connects first to an interface indicated by the preference order.

The above embodiment discloses that the signaling message comes directly from the first mobile terminal 52 to the second mobile terminal 54. In another embodiment, the first mobile terminal 52 may send the signaling message first to a network server at some instant. The network server then relays the signaling message to the second mobile terminal 54 automatically or when the second mobile terminal 54 requests address information of the first mobile terminal 52.

FIG. 5b illustrates another possible embodiment in which the invention may be used. FIG. 5b illustrates another possible embodiment in which the invention may be used. The system disclosed in FIG. 5b comprises a mobile terminal 52 and a data terminal 54. The mobile terminal 52 is connected to the Internet 50 e.g. via the General Packet Radio System (GPRS) or 3^{rd} generation mobile packet data connection. The data terminal 54 may be a computer or a mobile terminal. The mobile terminal is e.g. a mobile phone or any other appropriate device. For simplicity, the data terminal 54 is also a mobile terminal in this example. The first mobile terminal 52 is connected also to a local network 56 via another wireless connection, e.g. a Wireless Local Area Network (WLAN) connection.

In this embodiment, the first mobile terminal 52 has only one public interface, namely IP1, to which is assigned a public IP address. An interface IP2 is a local interface, which is not connected to the Internet 50. Therefore, the first mobile terminal 52 may receive information from the second mobile terminal 54 only via the interface IP1.

As disclosed e.g. in the description of FIG. 1, the first mobile terminal 52 sends a signaling message to the second mobile terminal 54 and informs where (which interface) to connect to download something. The second mobile terminal 54 connects to the interface IP1 and performs the download. The first mobile terminal 52 may have set a preference order for the interfaces in the signaling message. Therefore, the second mobile terminal 54 connects first to an interface indicated by the preference order.

FIG. 5c illustrates another possible embodiment in which the invention may be used. The system disclosed in FIG. 5c comprises a mobile terminal 52 and a data terminal 54. The mobile terminal 52 is connected to the Internet 50 e.g. via the General Packet Radio System (GPRS) or 3^{rd} generation mobile packet data connection. The data terminal 54 may be a computer or a mobile terminal. The mobile terminal is e.g. a mobile phone or any other appropriate device. For simplicity, data terminal 54 is also a mobile terminal in this example.

The first mobile terminal 52 is connected also to a local network 56 via another wireless connection, e.g. a Wireless Local Area Network (WLAN) connection. The second mobile terminal 54 is connected also to another local network 58 via another wireless connection, e.g. a Wireless Local Area Network (WLAN) connection. In this embodiment, the local networks 56 and 58 are different local networks, and neither of them is connected to the Internet 50. Furthermore, in this embodiment, the first mobile terminal 52 has one public interface IP1 and one local interface IP2. Therefore, the first mobile terminal 52 may receive information from the second mobile terminal 54 only via the public interface IP1. Similarly, the second mobile terminal 54 has one public interface and one local interface.

As disclosed e.g. in the description of FIG. 1, the first mobile terminal 52 sends a signaling message to the second mobile terminal 54 and informs where (which interface) to connect to download something. The second mobile terminal 54 connects to the interface IP1 and performs the download. The first mobile terminal 52 may have set a preference order for the interfaces in the signaling message. Therefore, the second mobile terminal 54 connects first to an interface indicated by the preference order.

FIG. 5d illustrates another possible embodiment in which the invention may be used. The system disclosed in FIG. 5d comprises a mobile terminal 52 and a data terminal 54. The mobile terminal 52 is connected to the Internet 50 e.g. via the General Packet Radio System (GPRS) or 3^{rd} generation mobile packet data connection. The data terminal 54 may be a computer or a mobile terminal. The mobile terminal is e.g. a mobile phone or any other appropriate device. For simplicity, data terminal 54 is also a mobile terminal in this example. The first mobile terminal 52 is connected also to a local network 56 via another wireless connection, e.g. a Wireless Local Area Network (WLAN) connection. The second mobile terminal 54 is also connected to the same local network 56. Furthermore, in this embodiment, the first mobile terminal 52 has one public interface IP1 and one local interface IP2. Therefore, the first mobile terminal 52 may receive information from the second mobile terminal 54 via both the public interface IP1 and the local interface. Similarly, the second mobile terminal 54 has one public interface and one local interface.

As disclosed e.g. in the description of FIG. 1, the first mobile terminal 52 sends a signaling message to the second mobile terminal 54 and informs where (which interface) to connect to download something. The second mobile terminal 54 connects to the interface IP1 or IP2 and performs the download. The first mobile terminal 52 may have set a preference order for the interfaces in the signaling message. Therefore, the second mobile terminal 54 connects first to an interface indicated by the preference order.

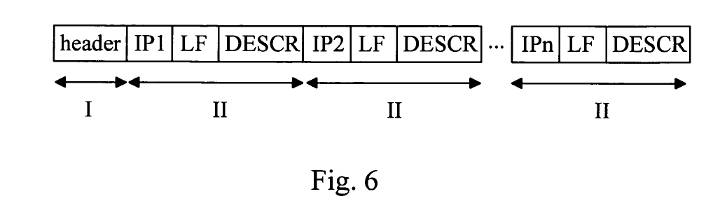

FIG. 6 discloses one embodiment of a possible data structure that may be used in the solution disclosed in the invention. A message constructed using the data structure may be transmitted in an extension field of an existing peer-to-peer protocol. Examples of such peer-to-peer protocols are BitTorrent, Gnutella etc. Basically, the data structure consists of parts I and II. Additionally, there may be several II parts in an actual signaling message.

The data structure comprises a header field that identifies the meaning of the message to the intended recipient. The header field may take any appropriate form, typically being a few bits of length. An IP1 field identifies an IP address of a first communication interface of a mobile terminal. The mobile terminal disclosed in the invention comprises at least two communication interfaces. These interfaces, among other things, are identified by the data structure.

An LF field identifies whether the IP1 interface is a local interface. In one embodiment, only one bit is needed. For example, “1” depicts that the IP1 interface is a local interface and “0” depicts that the IP1 interface is not a local interface. In another embodiment of FIG. 6, the LF field is optional.

A DESCR field identifies a host descriptor for the IP1 interface. The DESCR field is needed when the IP1 interface is a local interface. The host descriptor is e.g. a Media Access Control (MAC) address of the local communication interface or a hash of the MAC address. The hash may have been computed with any appropriate hashing function, e.g. SHA1 (Secure Hashing Algorithm) or MD5 (Message Digest). The hash or MAC address may not be fully in the signaling message. For example, in one embodiment 32 last bits of it may be used. The host descriptor may also indicate whether a hash function is used or not and which hash function is used. In another embodiment, an indicator indicating whether a hash function is used and which hash function is used may be a separate indicator from the host descriptor. In one embodiment, the DESCR field itself indicates whether a hash function is used and which hash function is used. In another embodiment, there may be one or more additional fields in the data structure for these purposes.

Each communication interface has corresponding definitions in the signaling message. As indicated in FIG. 6, there may be several communication interfaces identified by the separate II parts.

As a summary, the solution disclosed in the invention may be implemented as a protocol extension of existing point-to-point protocols, such as BitTorrent, Gnutella etc.

It is obvious to a person skilled in the art that with the advancement of technology, the basic idea of the invention may be implemented in various ways. The invention and its embodiments are thus not limited to the examples described above, instead they may vary within the scope of the claims.

1. A method of initiating communication from a peer-to-peer application of a mobile terminal, the method comprising:
determining the number of communication interfaces in the mobile terminal;
adding internet protocol addresses of each communication interface to a signaling message, when the number of communication interfaces is at least two;
adding at least one host descriptor of the mobile terminal to the signaling message; and
sending the signaling message to a receiving entity via a public communication interface.

2. The method according to claim 1, further comprising:
determining, for each communication interface, whether a communication interface is a local communication interface, and
when the interface is a local communication interface, adding a local network indicator for the communication interface in the signaling message.

3. The method according to claim 1, further comprising:
ordering the communication interfaces in a preference order in the signaling message.

4. The method according to claim 1, further comprising:
adding a separate host descriptor for each communication interface in the signaling message.

5. The method according to claim 1, wherein the host descriptor comprises at least part of a Media Access Control address of the mobile terminal.

6. The method according to claim 1, wherein the receiving entity is a data terminal.

7. The method according to claim 1, wherein the receiving entity is a server computer.

8. A method of establishing a connection from a data terminal to a mobile terminal, the method comprising:
receiving, with the data terminal, a signaling message comprising internet protocol addresses of at least two communication interfaces of the mobile terminal, each communication interface being identified by a corresponding internet protocol address;
selecting a first internet protocol address from the signaling message, the internet protocol address corresponding to a communication interface;
validating a host descriptor comprised in the signaling message, the host descriptor corresponding to the communication interface;
initiating communication with the internet protocol address corresponding to a validated host descriptor; and
selecting a next internet protocol address for validation and communication initiation if the validating step or initiating step fails.

9. The method according to claim 8, further comprising:
determining whether the first internet protocol address in the signaling message belongs to a local network;
if the first internet protocol address is a local network address, determining whether the data terminal belongs to the local network; and
selecting the next internet protocol address from the signaling message if the data terminal does not belong to the local network.

10. The method according to claim 8, further comprising:
selecting the internet protocol addresses of the communication interfaces from the signaling message according to a preference order.

11. The method according to claim 8, further comprising:
determining, based on a local network indicator, whether the first internet protocol address in the signaling message belongs to a local network.

12. The method according to claim 8, wherein the host descriptor comprises at least part of a Media Access Control address.

13. The method according to claim 8, wherein the receiving step comprises receiving the signaling message from the mobile terminal.

14. The method according to claim 8, wherein the receiving step comprises receiving the signaling message from a server computer.

15. A mobile terminal configured to initiate communication with a peer-to-peer application, the mobile terminal being configured to:
determine the number of communication interfaces in the mobile terminal;
add internet protocol addresses of each communication interface to a signaling message when the number of communication interfaces is at least two;
add at least one host descriptor of the mobile terminal to the signaling message; and
send the signaling message to a receiving entity via a public communication interface.

16. The mobile terminal according to claim 15, further configured to:
determine, for each communication interface, whether a communication interface is a local communication interface, and
when the interface is a local communication interface, add a local network indicator for the communication interface in the signaling message.

17. The mobile terminal according to claim 15, further configured to:
order the communication interfaces in a preference order in the signaling message.

18. The mobile terminal according to claim 15, further configured to:
add a separate host descriptor for each communication interface in the signaling message.

19. The mobile terminal according to claim 15, wherein the at least one host descriptor comprises at least part of a Media Access Control address of the mobile terminal.

20. A data terminal configured to establish a peer-to-peer connection with a mobile terminal, the data terminal being configured to:
receive a signaling message comprising internet protocol addresses of at least two communication interfaces of the mobile terminal, each communication interface being identified by a corresponding internet protocol address;
select a first internet protocol address from the signaling message, the first internet protocol address corresponding to a communication interface;
validate a host descriptor comprised in the signaling message, the host descriptor corresponding to the communication interface;
initiate communication with the first internet protocol address corresponding to a validated host descriptor; and
select the next internet protocol address for validation and communication initiation if the validating step or initiating step fails.

21. The data terminal according to claim 20, further configured to:
determine whether the first internet protocol address in the signaling message belongs to a local network;
if the internet protocol address belongs to the local network, determine whether the data terminal belongs to the local network; and
select the next internet protocol address from the signaling message if the data terminal does not belong to the local network.

22. The data terminal according to claim 20, further configured to:
select internet protocol addresses of the communication interfaces from the signaling message according to a preference order.

23. The data terminal according to claim 20, further configured to:
determine, based on a local network indicator, whether the internet protocol address in the signaling message belongs to the a local network.

24. The data terminal according to claim 20, wherein the host descriptor comprises at least part of a Media Access Control address.

25. The data terminal according to claim 20, wherein the data terminal is configured to receive the signaling message from the mobile terminal.

26. The data terminal according to claim 20, wherein the data terminal is configured to receive the signaling message from a server computer.

27. The data terminal according to claim 20, wherein the data terminal is a mobile terminal.

28. A computer program for initiating communication, embodied on a computer-readable medium, the computer program comprising code adapted to perform the following steps when executed on a data-processing device:
determining the number of communication interfaces in a mobile terminal;
adding internet protocol addresses of each communication interface to a signaling message when the number of communication interfaces is at least two;
adding at least one host descriptor of the mobile terminal to the signaling message; and
sending the signaling message to a receiving entity via a public communication interface.

29. The computer program according to claim 28, further adapted to perform the following steps when executed on said data-processing device:
determining, for each communication interface, whether a communication interface is a local communication interface, and
when the interface is a local communication interface, adding a local network indicator for the communication interface in the signaling message.

30. The computer program according to claim 28, further adapted to perform the following step when executed on said data-processing device:
ordering the communication interfaces in a preference order in the signaling message.

31. The computer program according to claim 28, further adapted to perform the following step when executed on said data-processing device:
adding a separate host descriptor for each communication interface in the signaling message.

32. The computer program according to claim 28, wherein the host descriptor comprises at least part of a Media Access Control address of the mobile terminal.

33. A computer program for establishing a peer-to-peer connection, embodied on a computer-readable medium, the computer program comprising code adapted to perform the following steps when executed on a data-processing device:
receiving, with a data terminal, a signaling message comprising internet protocol addresses of at least two communication interfaces of the mobile terminal, each communication interface being identified by a corresponding internet protocol address;
selecting a first internet protocol address from the signaling message, the internet protocol address corresponding to a communication interface;
validating a host descriptor comprised in the signaling message, the host descriptor corresponding to the communication interface;
initiating communication with the first internet protocol address corresponding to a validated host descriptor; and
selecting the next internet protocol address for validation and communication initiation if the validating step or initiating step fails.

34. The computer program according to claim 33, further adapted to perform the following steps when executed on said data-processing device:
determining whether the first internet protocol address in the signaling message belongs to a local network; and if the internet protocol address is a local network address,
determining whether the data terminal belongs to the local network; and
selecting the next internet protocol address from the signaling message if the data terminal does not belong to the local network.

35. The computer program according to claim 33, further adapted to perform the following steps when executed on said data-processing device:
selecting internet protocol addresses of the communication interfaces from the signaling message according to a preference order.

36. The computer program according to claim 33, further adapted to perform the following steps when executed on said data-processing device:
determining, based on a local network indicator, whether the internet protocol address in the signaling message belongs to a local network.

37. The computer program according to claim 33, wherein the host descriptor comprises at least part of a Media Access Control address.

38. A data structure for communication initiation with a peer-to-peer application, the data structure comprising:
at least two internet protocol addresses, wherein each internet protocol address identifies a communication interface of a mobile terminal; and
at least one host descriptor of the mobile terminal.

39. The data structure according to claim 38, further comprising:
a local network indicator for each local communication interface.

40. The data structure according to claim 38, wherein the communication interfaces are ordered in a preference order.

41. The data structure according to claim 38, wherein the host descriptor comprises at least part of a Media Access Control address of the mobile terminal.
